(19) United States
(12) Patent Application Publication
(10) Pub. No.: US 2014/0095305 A1
(43) Pub. Date: Apr. 3, 2014

(54) SYSTEM AND METHOD FOR INCENTIVE BASED DRIVING

(71) Applicant: Cartasite, Inc., Denver, CO (US)

(72) Inventors: David Armitage, Golden, CO (US); Mark Mason, Thornton, CO (US)

(73) Assignee: Cartasite, Inc., Denver, CO (US)

(21) Appl. No.: 14/043,417

(22) Filed: Oct. 1, 2013

Related U.S. Application Data
(60) Provisional application No. 61/708,934, filed on Oct. 2, 2012.

(51) Int. Cl. G06Q 30/02

(52) U.S. Cl. CPC G06Q 30/0251
USPC 705/14.49

(57) ABSTRACT

Methods and systems for providing incentives for safe driving include collecting data from a vehicle monitoring system, analyzing the data from the vehicle monitoring system to create a driver report with an overall score, delivering the driver report to a target driver, and rewarding the target driver based on at least the overall score.

### CROSS REFERENCE TO RELATED APPLICATIONS

This application claims priority to, and benefit from, provisional patent application Ser. No. 61/708,934, entitled “SYSTEM AND METHOD FOR INCENTIVE BASED DRIVING”, filed Oct. 2, 2012, which is incorporated by reference for all purposes.

### TECHNICAL BACKGROUND

Performance monitoring tools are often used to assess the operation of a vehicle, such as an automobile or mass transit vehicle. Such tools can analyze both the performance of the vehicle itself, as well as the operational behavior of the person operating the vehicle. This assessment can be achieved in both a real time and non-real time manner.

Currently, standard mechanisms have been developed to assist vehicle monitoring. One example is the OBD2 (On Board Diagnostics) system developed for monitoring the operation of an automobile. Via an OBD2 system, it is now possible to monitor dozens, if not hundreds, of operation characteristics of a vehicle. Such characteristics can include the speed of the vehicle, the acceleration of the vehicle, the amount of time idling, as well as other characteristics of an individual's driving habits.

### OVERVIEW

A method and system of providing incentives for safe driving includes collecting data from a vehicle monitoring system, analyzing the data from the vehicle monitoring system to create a driver report with an overall score, delivering the driver report to a target driver, and rewarding the target driver based on at least the overall score.

### BRIEF DESCRIPTION OF THE DRAWINGS

FIG. 1 illustrates a driving report system according to one example.

FIG. 2 illustrates the operation of a driving report system according to one example.

FIG. 3 illustrates a driving report system according to one example.

FIG. 4 illustrates a driving report according to one example.

FIG. 5 illustrates a driving report according to one example.

FIG. 6 illustrates a driving report according to one example.

FIG. 7 illustrates a map for providing rewards to drivers according to one example.

FIG. 8 illustrates a link of driving scores and social networks according to one example.

FIG. 9 illustrates a driving report system according to one example.

FIG. 10 illustrates a driver analysis system according to one example.

FIG. 11 illustrates a target driver computing system according to one example.

### DESCRIPTION

Systems and methods are provided herein to create incentives for safe driving. The method includes collecting data from a vehicle monitoring system, analyzing the data from the vehicle monitoring system to create a driver report with an overall score, delivering the driver report to a target driver, and giving an opportunity to the target driver to collect rewards based on the driver report.

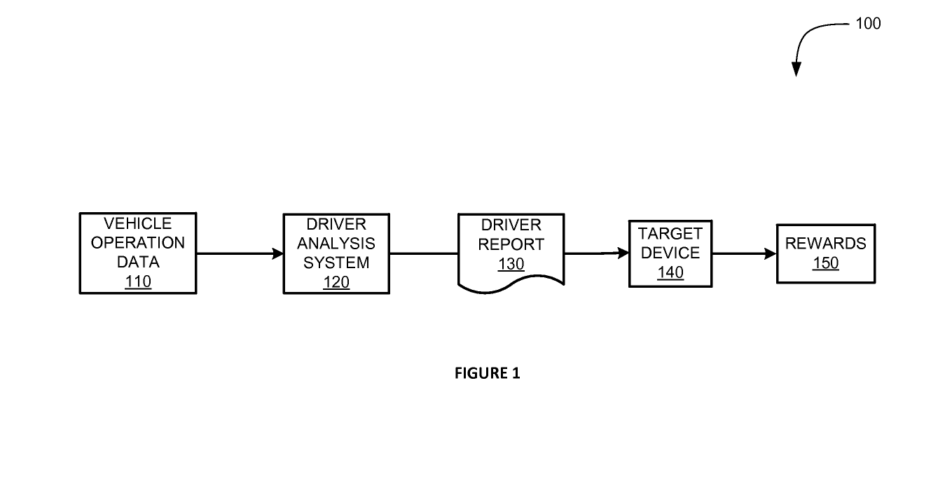

FIG. 1 illustrates driving report system 100 according to an example. Driving report system 100 can include driver analysis system 120, which is capable of receiving vehicle operation data 110 from at least one vehicle. Driver analysis system 120 generates a driver report 130 based on the operation data. Driver report 130 may be delivered to target device 140, which is associated with a target driver. Target device 140 can then use driving report 130 to collect rewards 150.

The rewards may be identified by the driver analysis system 130, target device 140 or any other system. The rewards may be offers by another person, such as a parent or other person. The rewards may also be offered by local businesses for marketing to the type of driver or demographic.

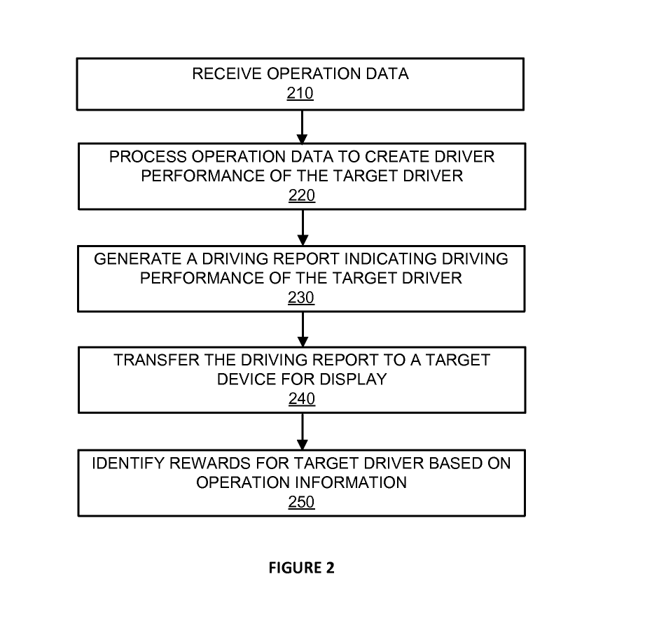

FIG. 2 is a flow diagram illustrating a method of operating driving report system 100 according to an example. Driver analysis system 120 receives operation data 110 from one or more vehicles (step 210). Next, driver analysis system 120 processes the operation data to determine the driving performance of target driver 140 based on the operation data (step 220). Based on the operation data, driver analysis system 120 generates driving report 130 that identifies the driving performance of target driver 140 (step 230) and transfers driving report 130 to a target device 140 for viewing by target driver (step 240). The report may include an overall score or safety score, such as a score out of 100, and may also include scores in other categories. Additionally, driving report 130 may provide target driver with a comparison to a peer group of similar drivers.

Next, target driver is provided with an opportunity for rewards based on at least the overall score in driving report 130, and/or operation data (step 250). Examples of rewards include gas money from friends or relatives, coupons and other rewards at restaurants, monetary rewards such as scholarships, or any other incentive which may increase the likelihood of the driver safer driving.

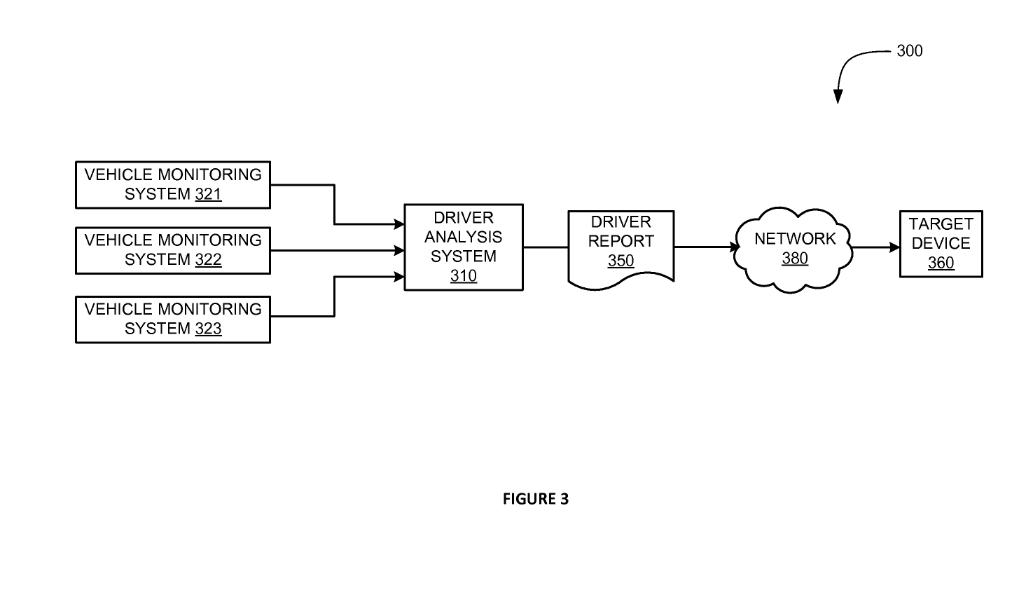

FIG. 3 illustrates an example driver report system 300. Driving report system 300 comprises a driver analysis system 310 that receives vehicle operation data from vehicle monitoring systems 321-323 and uses this data to generate a driver report 350, which is delivered to a target device 360 over a network 380.

In FIG. 3, driver analysis system 310 receives vehicle operation data from vehicle monitoring systems 321-323. Vehicle monitoring systems 321-323 are electronic devices, which are on board each individual vehicle and collect data about the operation of the vehicle over a period of time. The data includes information about how the vehicle is being used and the driver's operational behavior characteristics. Additionally, operation data may also be received from the target device 360. It may be determined that target device 360 is in the monitored vehicle, and use information and other information may be received from target device 360.

Periodically or upon request, each of the vehicle monitoring systems 321-323 and/or target device 360 transfers this data to driver analysis system 310. The vehicle operation data may include data describing: acceleration, speed, braking, lateral acceleration, fuel consumption, emissions, location, driving hours, maintenance, global positioning information, as well as potentially many other types of vehicle diagnostics and information about how the vehicle is being operated.

After receipt of data from vehicle monitoring systems 321-323, or at a specified interval, driver analysis system 310 begins the process of generating driving report 350 for a particular driver, target driver. This report could be generated once a day, once a week, once a month, or for any other time period. Driving report 350 could include a total driver performance score based on an ideal driving perfect score or could be based on the scores of other drivers. The total driver performance score could be out of 100 or could be a scored on any other scoring system.

The performance, overall, and/or safety score may be log normalized to create a final performance, overall, and/or safety score. This log normalized final score may make it appear that the driver may be indicted as being a better than average driver. Most drivers believe they are better than average, and this log normalization may reinforce that belief and increase the confidence of the driver in the system. The score may be log normally distributed. This may also motivate the driver to improve their score, or try to get to a perfect score, which increases the likelihood of the driver driving more safely than without this system.

Driving report 350 may also include statistics and scores about individual categories to notify target driver about possible areas to improve. These individual categories may include information regarding acceleration, speed, braking, lateral acceleration, fuel consumption, emissions, location, driving hours, maintenance, as well as potentially many other types of vehicle diagnostics and information about how the vehicle is being operated.

Further, driving report 350 may include rewards that are linked when driving report 350 is generated. Such rewards may include coupons, monetary awards, or any other type of award from anyone.

Driver analysis system 310 transfers driving report 350 to a target device 360 for viewing by target driver by sending it over a network 380. Network 380 may include Bluetooth-type communication capabilities, global positioning system capabilities, satellite communication capability, Wi-Fi, the Internet, and/or cellular communication capabilities and/or combinations thereof.

Target driver receives driving report 350 over network 380 and views it on a target device. The target device may be a personal computer, mobile phone, mobile Internet terminal, or other similar electronic device.

Driving report 350 may be transmitted in the form of an email, text message, displayed on a web page, presented in a web based software application, and/or any type of indication or display. Driving report 350 may also be incorporated into a software document, such as a MS Word file, a PDF file, a Power Point file, or the like. In yet another example, the analysis may be provided in a video format and played-out to the user. An audio presentation of the analysis may also be possible, such as by way of a voicemail message, a phone recording, or the like.

In one example, target driver may then use the delivered driver report 350 to claim rewards. Such rewards may include coupons, monetary awards, or any other type of award provided by anyone by any means.

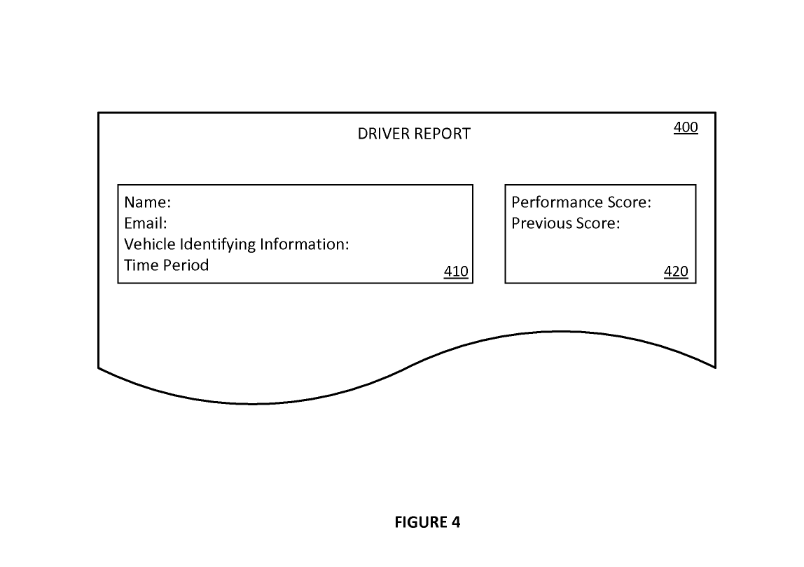

FIG. 4 illustrates an example driver report 400, according to an example. In information block 410, driver report 400 includes information identifying the driver, the driver's email address, the vehicle driven, and the time period to which the report applies. Additional information may be included to identify the target device of the driver, or the vehicle including make, model, license plate number, or other identifying information.

Block 420 includes the driver's performance or safety score for the current period as well as the previous performance or safety score. The performance or safety score may be a combined score that represents an overall score based on the various individual categories of operation characteristics, if more than one, which are reported, considered, combined, etc. Driver report 400 may also include multiple previous performance scores enabling the driver to easily see the performance trend over time, and/or any other information related to operation data, a vehicle, and/or the target driver.

In one example, driving report 400 may include rewards that are linked based on the driving report. These rewards could include coupons, monetary awards, or any other awards based on the operation or other data.

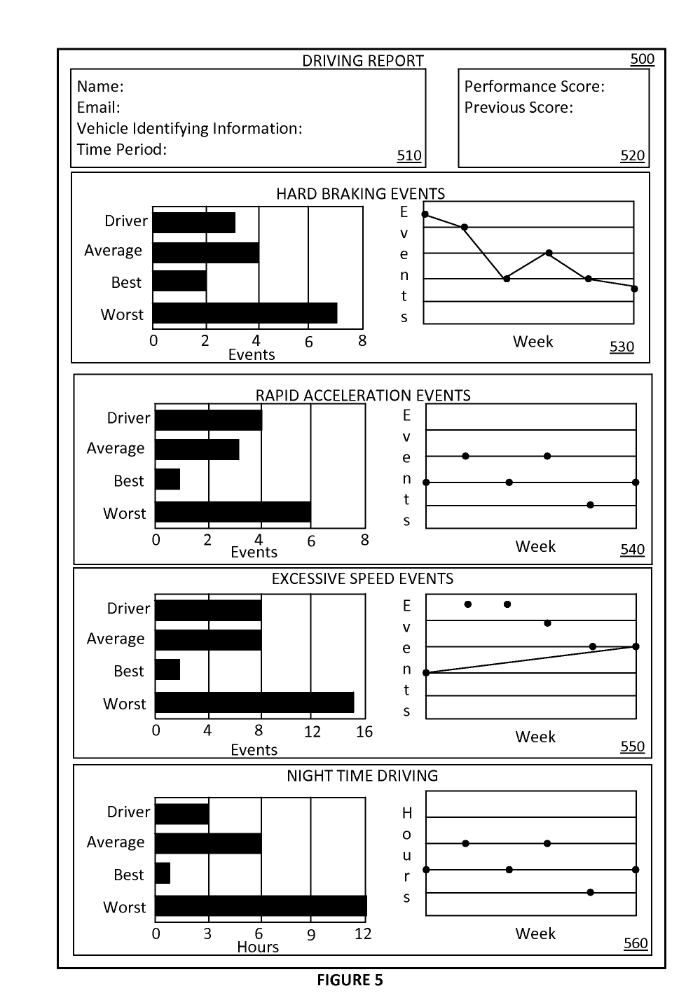

FIG. 5 illustrates an example of another driving report. In information block 510, driver report 500 includes information identifying the driver, the driver's email address, the vehicle driven, and the time period to which the report applies. Additional information may be included to identify the vehicle including make, model, license plate number, or other identifying information. If the driver drove multiple vehicles during the time period, each vehicle could be listed and the consolidated information could be included on driver report 500. Additional information may also include information from and about the target device.

Block 520 of driver report 500 includes the driver performance or safety score for the current period as well as the previous performance or safety score(s). The score may be a combined score, which represents an overall score based on the various individual categories of specific behaviors, which are received, reported and/or considered. Driver report 500 may also include multiple previous performance scores such that the driver can easily see the performance trend over time and/or relative to other drivers.

In addition, driving report 500 includes detailed reporting information on specific operational characteristics in blocks 530-560. Block 530 includes information on hard braking events for the target driver. The number of hard braking events the target driver had in the reporting period may be compared to the average for the peer group as well as to the drivers in the peer group who had the best and worst performance for the time period as measured by number of events. The number of events may be in comparison to predetermined numbers of events.

The events may be an absolute quantity. Rather than absolute quantity, the comparison could be based on a rate such as hard breaking events per hour, per week, or per hundred miles driven. Block 520 also includes a historical graphical representation illustrating the driver's hard braking event performance trend over time. Blocks 540, 550, and 560 provide similar illustrations of reporting information for rapid acceleration events, excessive speed events, and number of nighttime driving hours.

It will be recognized, that there are many other operational and behavioral parameters that may be analyzed and included in driver report 500. There are also many types of statistical analysis that may be performed on the data. The resulting driving information may be graphically presented and displayed in many different ways. The invention is not limited to the specific examples and methods of presentation provided in FIG. 5.

In addition to periodic driver reports, immediate alerts may be generated and provided as well. For example, if a number of hard braking events are detected beyond a threshold, the target driver or other person may be provided with an alert describing this driving behavior. Such an immediate alert may result in a reduction in hard braking events, thereby increasing safety and increasing the likelihood that the target driver will drive more safely. The alerts may be provided in real-time, but may also be provided some time later after the events are detected.

In one example, driving report 500 may include rewards that are linked based on the driving report and/or operation data. These rewards could include coupons, monetary awards, or any other awards based on the scores in the driving report.

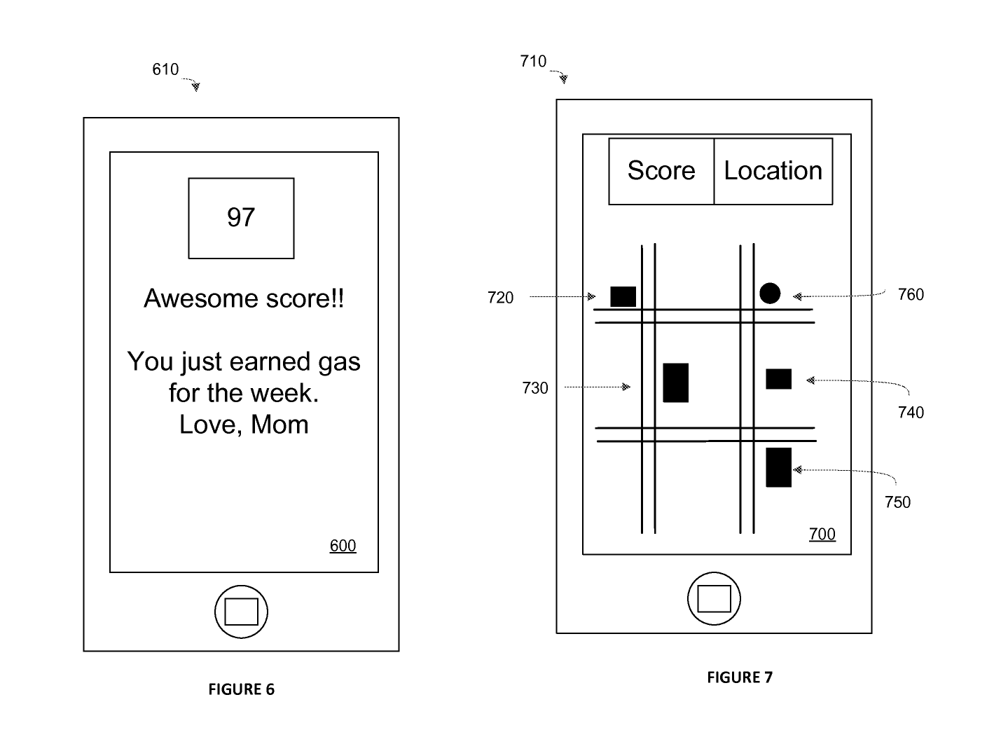

FIG. 6 illustrates a driver report 600 according to another example. This type of driving report could be presented through an application or web interface on a target device 610, such as a smart telephone, tablet computer, or any other form of mobile device. Driver report 600 includes the performance and/or safety score indicated by a 97.

Further, driver report 600 includes a linked reward for a particular score. In the present instance, the reward is gas money from a parent, but other rewards could be associated with the total driver performance score. Such rewards could include monetary rewards, as well as product rewards such as car insurance, car washes, food, clothes, or any other reward. These rewards could be given to the driver by relatives or friends that are associated with the driver's account, or could also be given by businesses that are linked with all driver accounts. Additionally, the rewards could have different stages depending on the score achieved. For example, a driver could receive fifty dollars for one score and one hundred dollars for another score.

Although the present example illustrates a single award associated with the driving report, it should be understood that any number of awards could be associated with the report. In one example, the driver could choose the relatives and friends that are associated with the account, such that the driver has control over who can see the driver's score. In another example, relatives and/or friends could have control over the account such that they decide who has the ability to view the driver's score and associate awards with the score. In another example, the control of the account could belong to a combination of the driver, friends, and relatives.

In one example of driver report 600, the overall score could be supplemented with further statistics and scores similar to driver report 500. These statistics and scores could include information about braking, acceleration, or any other category collected from the vehicle monitoring system. Further, driver report 600 can include comparisons between the score of the target driver and those of other drivers using the system, or comparisons to predetermined values of events.

In one example, the rewards will not be included with the driving report. Rather, the target driver can show the score contained in the driving report to claim the rewards.

FIG. 7 illustrates an example map 700 for providing rewards and incentives to drivers. Map 700 could be an application or web interface on a target device 710, such a smart phone, tablet computer, laptop computer, desktop computer, or the like. Map 700 includes a map with “pins” 720-750 representing places of interest that may include friend locations and/or reward locations. These reward locations may include restaurants, stores, or other businesses that provide free or discounted items based on particular driving scores. This interface may also include information about the specific rewards offered by the reward location.

The map may show the location of the target device 760. Further, map 700 may be interactive such that a user may view different portions of the map, zoom in, zoom out, and click on the reward locations to determine the rewards as well as the driving score needed to attain the rewards.

In one example, map 700 may provide only the locations from which the driver would receive rewards. The locations where the driver's score did not qualify for a reward would not be visible. In one example, map 700 may provide all locations that provide rewards, though the driver may not qualify for a reward at all locations.

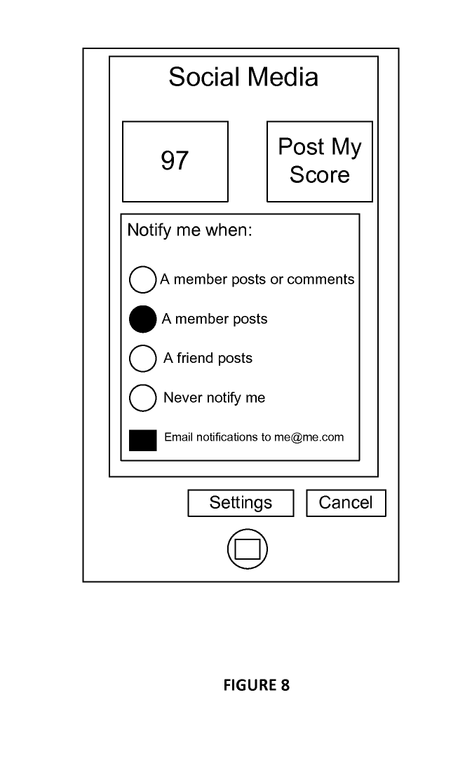

FIG. 8 illustrates a link of driving scores and social networks according to one example. In FIG. 8, the target driver is presented with their overall, performance, and/or safety score, and options of what they would like to do with the score. These options may include posting the score to Facebook®, Twitter®, or any other form of social network, or other site. Additionally, the page could allow the user to contact friends or family via email, text message, or any other form of communication.

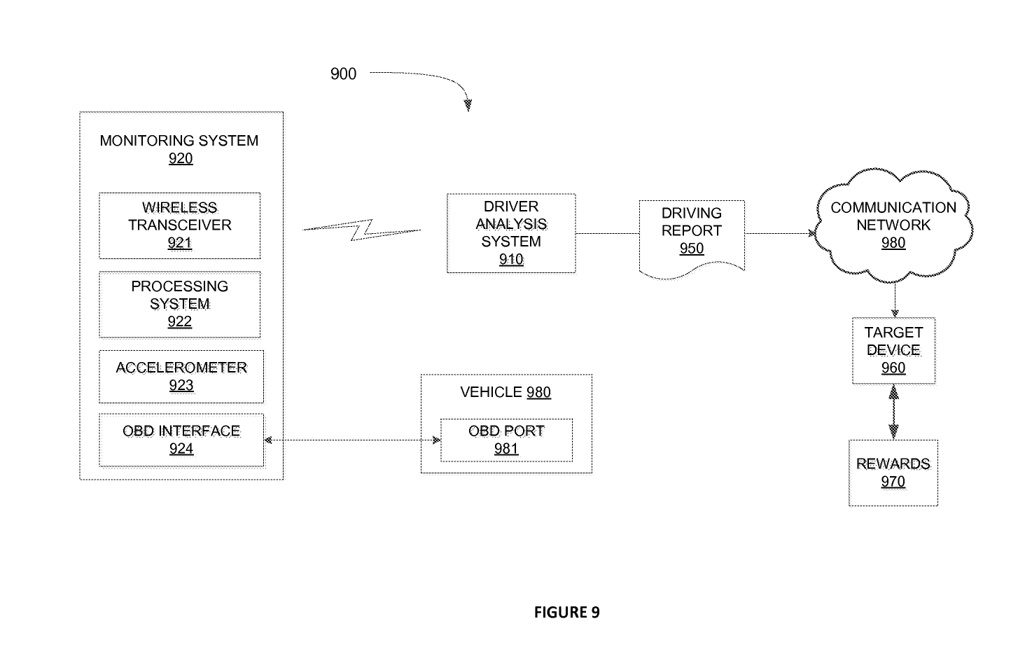

FIG. 9 illustrates driver report system 900, according to an example. Driver report system 900 con include driver analysis system 910, which receives operation data from vehicle monitoring system 920 and target device 960 through a wireless connection and uses the data to generate driving report 950 that is delivered to target device 960 over communication network 980. Driver report 950 may then be used in identifying and claiming rewards 970.

In FIG. 9, driver analysis system 910 receives operation data from vehicle monitoring system 920. Vehicle monitoring system 920 may include an electronic device, which is on board vehicle 980 and collects data regarding the operation of vehicle 980 over a period of time. Vehicle monitoring system 920 may interface to, and collect data from and about, vehicle 980 through a connection between On Board Diagnostic (OBD) interface 924 and OBD port 981 and/or CAN bus. The OBD port is a standardized interface, which allows vehicle monitoring system 920 to capture many different types of data from vehicle 980's electronic and engine management systems.

In addition to the operational data gathered through OBD port 981, vehicle monitoring system 920 gathers operational data from other sources as well. In one example, vehicle monitoring system 920 contains accelerometer 920 which is used to keep track of the speed of vehicle 980. This speed information may also be combined with the other operational data gathered.

Monitoring system 920 may gather location and speed information from other devices such as a global position system (GPS) receiver. The GPS may be included in, or external to, monitoring system 920. In addition, vehicle monitoring system 920 may collect vehicle operation data from other sensors or sources which are neither part of vehicle monitoring system 920 nor vehicle 980, such as from target device 960.

Monitoring system 920 may also include memory (such as flash memory), a processor, a real-time operating system, Bluetooth-type communication capabilities, global positioning system capabilities, satellite communication capability and/or cellular communication capabilities.

Processing system 922 in vehicle monitoring system 920 receives, processes, and stores all of the gathered vehicle operation data from monitoring system 920 and all other sensors, such that it can be transmitted at the appropriate time. In addition, other operation data may be received from external sources, such as, but not limited to, target device 960.

Vehicle monitoring system 920 uses wireless transceiver 921 to transmit the set of vehicle operation data to driver analysis system 910. This process may be performed frequently or may be performed only once each reporting period. The transmission may be initiated by either vehicle monitoring system 920 or by driver analysis system 910. The vehicle operation data may include data describing: acceleration, speed, braking, fuel consumption, location, driving hours, maintenance, as well as potentially many other measures of driver behavior, vehicle operation data, vehicle diagnostics, and other information.

Driver analysis system 910 is also configured to process the operation data to determine driving performance of target driver 960. One example is rapid acceleration events. Through the course of operation, vehicle monitoring system 920 gathers data each time the vehicle accelerates at a rate which exceeds an expected or predetermined threshold. This acceleration information may be gathered from the electronic systems of the vehicle as reported through OBD port 981 or may be gathered from accelerometer 923 or other device. While all drivers may have an occasional, legitimate need to accelerate rapidly, a higher rate of these events may suggest aggressive driving, excessive speed, or other undesirable driver behaviors. Thus, the higher rate may result in a lower total driver performance score.

Based at least in part on the results of the analysis, driver analysis system 910 generates driving report 950, which identifies the driving performance of the target driver and can also link that performance to rewards for the target driver. In the example of monetary rewards, money may be transferred to a target driver's bank or gas account based on the performance score. In other examples, coupons or vouchers can be included with driving report 950 such that target driver 960 receives the performance score and the rewards together.

After creating driving report 950, driver analysis system 910 transfers driving report 950 to a target device 960 for viewing by target driver by sending it over communication network 980. Target driver receives driving report 950 over communication network 980 through a target device 960 and views the report on that device.

The target device 960 may be a personal computer, mobile phone, mobile internet terminal, or other type of electronic communication device. Driving report 950 may be transmitted in the form of an email, text message, web-based application, or displayed on a web page. Driving report 950 may also be incorporated into a software document, such as a MS Word file, a PDF file, a Power Point file, or the like. In yet another example, the analysis may be provided in a video format and played-out to the user. An audio presentation of the analysis may also be possible, such as by way of a voicemail message, a phone recording, or the like. The report or any other operation data may also be transmitted to another device/location, such as to a parent or supervisor, etc.

Once target driver receives driving report 950, target driver may claim any vouchers, coupons, or other rewards 970 that are associated with driving report 950. These rewards 970 could include any reward included in driving report 950, any rewards available on map 700, or any other method of matching a driving score to a reward.

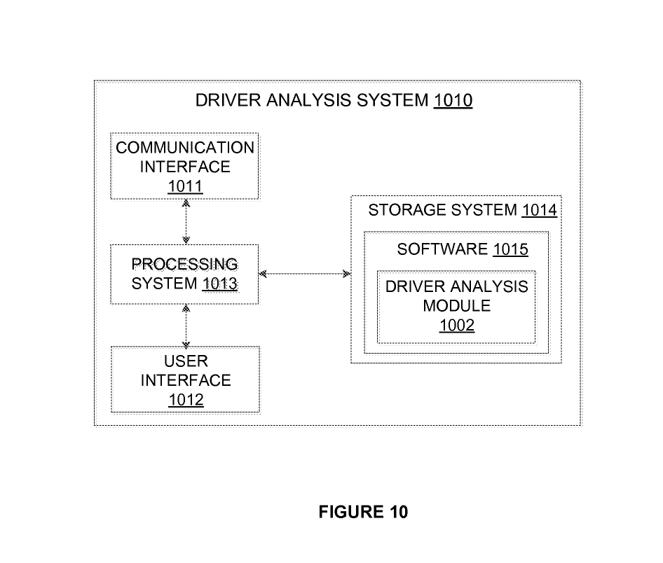

FIG. 10 illustrates driver analysis system 1010, which is an example of the driver analysis systems in previous figures. Driver analysis system 1010 is capable of receiving and processing operation data for a vehicle driven by a target driver. Driver analysis system 1010 processes the operation data to generate an analysis of the driving behavior of the target driver. Driver analysis system 1010 then provides a driving report to the target driver.

Driver analysis system 1010 includes communication interface 1011, user interface 1012, processing system 1013, storage system 1014, and software 1015. Software 1015 includes driver analysis module 1002. Processing system 1013 is linked to communication interface 1011 and user interface 1012. Software 1015 is stored on storage system 1014. In operation, processing system 1013 executes software 1015, including driver analysis module 1002, to operate as described herein.

Communication interface 1011 comprises a network card, network interface, port, or interface circuitry that allows storage system 1014 to obtain vehicle performance data. Communication interface 1011 may also include a memory device, software, processing circuitry, or some other communication device.

User interface 1012 comprises components that interact with a user to receive user inputs and to present media and/or information. User interface 1012 may include a speaker, microphone, buttons, lights, display screen, mouse, keyboard, or some other user input/output apparatus—including combinations thereof. User interface 1012 may be omitted in some examples.

Processing system 1013 may comprise a microprocessor and other circuitry that retrieves and executes software 1015, including driver analysis module 1002, from storage system 1014. Storage system 1014 comprises a disk drive, flash drive, data storage circuitry, or some other memory apparatus. Processing system 1013 is typically mounted on a circuit board that may also contain storage system 1014 and portions of communication interface 1011 and user interface 1012.

Software 1015 comprises computer programs, firmware, or some other form of machine-readable processing instructions. Software 1015 may include an operating system, utilities, drivers, network interfaces, applications, virtual machines, or some other type of software, such as driver analysis module 1002. When executed by processing system 1013, software 1015 directs processing system 1013 to operate as described herein.

In operation, driver analysis module 1002, when executed by processing system 1000, operates as follows. Driver analysis module 1002 directs computer system 1000 to obtain operation data for a vehicle driven by a target driver. For instance, via communication interface 1011, computer system 1000 may communicate with a system capable of providing operation data. It should be understood that computer system 1000 may communicate remotely or directly with such an interface.

It should be understood that the analysis may be provided directly to the user by way of user interface 1012, such as by displaying the analysis on a display screen. However, it should also be understood that the analysis may be provided, by way of communication interface 1011, to a user device capable of presenting the analysis to the user.

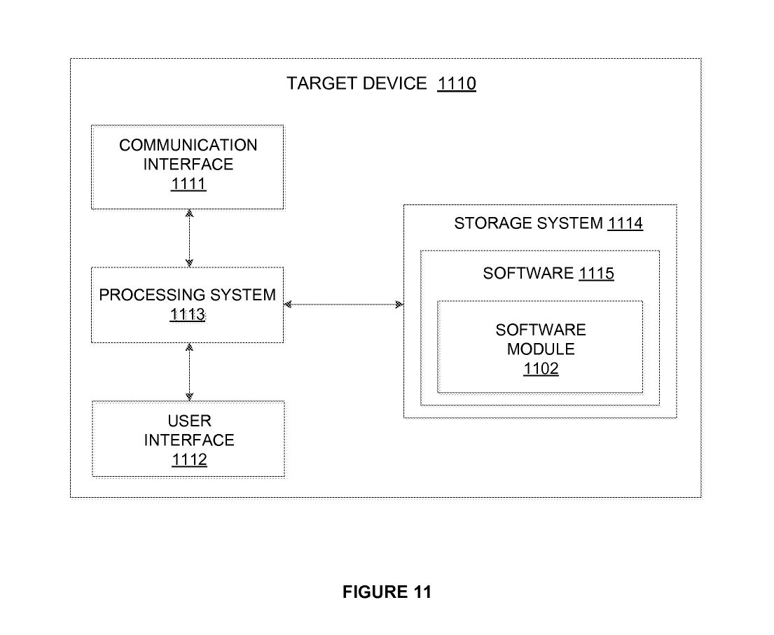

FIG. 11 illustrates a target device 1110, which is an example of the target device discussed in previous figures. Target device 1110 is capable of receiving a driver report and displaying the report in a similar fashion to the reports in the previous figures. Target device 1110 is also capable of displaying map 700 and other driving rewards for the target driver.

Target device computing system 1110 includes communication interface 1111, user interface 1112, processing system 1113, storage system 1114, and software 1115. Software 1115 includes software module 1102. Processing system 1113 is linked to communication interface 1111 and user interface 1112. Software 1115 is stored on storage system 1114. In operation, processing system 1113 executes software 1115, including software module 1102, to display driving reports, maps, or rewards including combinations thereof.

Communication interface 1111 comprises a network card, network interface, port, or interface circuitry that allows computing system 1110 to receive driving reports and information for map 700, and to provide operation data to the monitoring system, and the driver analysis system. Communication interface 1111 may also include a memory device, software, processing circuitry, or some other communication device.

User interface 1112 comprises components that interact with a user to receive user inputs and to present media and/or information. User interface 1012 may include a speaker, microphone, buttons, lights, display screen, mouse, keyboard, or some other user input/output apparatus—including combinations thereof.

Processing system 1113 may comprise a microprocessor and other circuitry that retrieves and executes software 1115, including software module 1102, from storage system 1114. Storage system 1114 comprises a disk drive, flash drive, data storage circuitry, or some other memory apparatus. Processing system 1113 is typically mounted on a circuit board that may also contain storage system 1114 and portions of communication interface 1111 and user interface 1112.

Software 1115 comprises computer programs, firmware, or some other form of machine-readable processing instructions. Software 1115 may include an operating system, utilities, drivers, network interfaces, applications, virtual machines, or some other type of software, such as software module 1102. When executed by processing system 1113, software 1115 directs processing system 1113 to display the driving report, map 700, rewards, or any other driving information about the target driver including combinations thereof.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a driver report system, the method comprising:
receiving, by a server, operation data from at least one vehicle monitoring system corresponding to at least one vehicle operated by a target driver;
processing the operation data, by a processor, from the at least one vehicle monitoring system to create a driver report comprising an overall score for the target driver based at least in part on the operational data;
transferring the driver report to a target device for viewing by the target driver; and
identifying reward opportunities to the target driver based at least in part on the overall score.

2. The method of claim 1, wherein the operation data is received at a communication interface in the driver analysis system from a monitoring system located adjacent the at least one vehicle, and wherein the driver report and the reward opportunities are transferred from the communication interface to the target device.

3. The method of claim 2, further comprising powering the monitoring system from an On Board Diagnostic (OBD) port on the vehicle and gathering at least a portion of the vehicle operation data from a source other than the OBD port.

4. The method of claim 3, wherein the source other than the OBD port comprises an accelerometer.

5. The method of claim 2, wherein the monitoring system comprises memory, a processor, a real-time operating system, Bluetooth-type communication capabilities, global positioning system capabilities, satellite communication capability and/or cellular communication capabilities.

6. The method of claim 1, wherein a final overall score is based at least in part on log normalized ranking of the overall score.

7. The method of claim 1, wherein the rewards are offered by businesses generally near the target device.

8. The method of claim 2, wherein the communication interface communicates with the monitoring system and the target device at least in part via cellular-type communication.

9. The method of claim 2, wherein the monitoring system communicates with the target device at least in part via blue-tooth-type communication.

10. A driver analysis system comprising:
a communication interface configured to receive vehicle operation data corresponding to operation of one or more vehicles operated by a driver;
a processing system configured to process at least a portion of the vehicle operation data to determine operation performance of the target driver, and generate a driver report, which is based at least in part on the operation performance of the target driver;
the communication interface further configured to transmit the driver report to a target device for viewing by the target driver, and identify reward opportunities to the target driver based at least in part on the operation performance.

11. The driver analysis system of claim 10, further comprising a monitoring system located adjacent the vehicle wherein the communication interface receives the vehicle operation data from the monitoring system and/or the target device, and wherein the driver report and the and reward opportunities is transmitted from the communication interface to the target device.

12. The driver analysis system of claim 11, wherein each of the monitoring system is powered from an On Board Diagnostic (OBD) port on the vehicle and gathers at least a portion of the vehicle operation data from a source other than the OBD port.

13. The driver analysis system of claim 12, wherein the source other than the OBD port comprises an accelerometer.

14. The system of claim 11, wherein the monitoring system comprises memory, a processor, a real-time operating system, Bluetooth-type communication capabilities, global positioning system capabilities, satellite communication capability and/or cellular communication capabilities.

15. The driver analysis system of claim 11, wherein the processing system generates a safety score representing a level of safety based at least in part on the operation performance of the target driver and includes the safety score in the driving report.

16. The system of claim 15, wherein a final safety score is based at least in part on log normalized distribution of the safety score.

17. The system of claim 11, wherein the communication interface communicates with the monitoring system and the target device at least in part via cellular-type communication.

18. The system of claim 11, wherein the monitoring system communicates with the target device at least in part via blue-tooth-type communication.

19. A driver analysis network comprising:
a plurality of monitoring systems located on board a plurality of vehicles operated by a driver, wherein the plurality of monitoring systems are configured to transmit vehicle operation data corresponding to operation of the plurality of vehicles;
a server configured to receive the vehicle operation data over a cellular communication network at a communication interface, process at least a portion of the vehicle operation data to determine driving performance of the target driver, generate an overall score based at least in part on the driving performance of the target driver, and transmit the overall score at the communication interface;
a target device configured to receive the overall score and display the score for viewing by the target driver; and
a monitoring system located adjacent the vehicle wherein the communication interface receives the vehicle operation data from the monitoring system and/or the target device, wherein the monitoring device comprises an accelerometer, Bluetooth-type communication capabilities, global positioning system capabilities, satellite communication capability and/or cellular communication capabilities, and/or combinations thereof.

20. The system of claim 19, wherein the communication interface communicates with the monitoring system and the target device at least in part via cellular-type communication and wherein the monitoring system communicates with the target device at least in part via blue-tooth-type communication.
